(19) United States
(12) Patent Application Publication
(10) Pub. No.: US 2011/0264893 A1
(43) Pub. Date: Oct. 27, 2011

(54) DATA PROCESSOR AND IC CARD

(75) Inventors: Takashi ENDO, Musashimurayama (JP); Shunsuke Ota, Kokubunji (JP)

(73) Assignee: RENESAS ELECTRONICS CORPORATION

(21) Appl. No.: 13/091,899

(22) Filed: Apr. 21, 2011

(30) Foreign Application Priority Data
Apr. 23, 2010 (JP) 2010-099812

(51) Int. Cl. G06F 9/312

(52) U.S. Cl. 712/205; 712/E09.033

(57) ABSTRACT

The data processor includes: a memory device for storing a program compiled by a compiler; and CPU operable to fetch an instruction code included by a program stored in the memory device. Further, the data processor has a filter for judging an instruction code which the compiler never outputs to limit, in action, CPU in case that CPU fetches the instruction code, which limits, in action, CPU in the case where the program is rewritten by not only an undefined instruction, but also an instruction other than an undefined instruction. The level of security is increased by limiting, in action, CPU.

### CROSS-REFERENCE TO RELATED APPLICATIONS

The Present application claims priority from Japanese application JP 2010-099812 filed on Apr. 23, 2010, the content of which is hereby incorporated by reference into this application.

### BACKGROUND

The present invention relates to a technique for sensing a read error of an instruction code from a memory device, and more specifically, a technique useful in e.g. the application to a microcomputer mounted on an IC card or the like.

With regard to a data processor typified by e.g. an IC card, such that data leakage, falsification and duplication are prevented by means of cipher processing, a method which involves causing a malfunction intentionally and estimating a cipher key based on the result of incorrect cipher arithmetic processing in the course of cipher processing has been in question in recent years. Examples of such method include a method for attacking RSA ciphers developed by AT&T Bellcore's laboratory in 1996, a method for attacking DES ciphers developed in 1997, and a method for attacking AES ciphers developed in 1999, and an attack can be made on many kinds of cipher systems.

Under the circumstances, a measure against malfunction is always taken in developing a software program for cipher computing. Such measure taken in many cases is that the result of computation is verified, and if the result of computation is incorrect, the result is not output. However, if causing an error in instruction fetch from a program, the arithmetic verification like this can be bypassed thereby to disable the measure against malfunction. Hence, a method for sensing an error in instruction fetch from a program has been studied as the alternative.

For instance, Japanese Unexamined Patent Publication No. JP-A-2006-18528 discloses a device which encrypts an execution program of a computer and stores the encrypted program in an external memory device, attempts to detect a wrong instruction in reading the stored program, and stops the execution of the program on detection of a wrong instruction. In regard to the data-protective device, no definition is provided about a wrong instruction. However, it is construed from the structure of the device that detection of an undefined instruction is performed. Further, Japanese Unexamined Patent Publication No. JP-A-5-324408 discloses a microcomputer in which after a false instruction word that the microcomputer cannot execute is stored in an instruction register, a unit for detecting an undefined instruction detects an undefined instruction, and outputs an undefined-instruction-trap-interrupt signal. Moreover, Japanese Unexamined Patent Publication No. JP-A-2009-187438 discloses a program for an IC card. According to the program, in case that data in a volatile memory on the IC chip is changed, and then an unintended instruction is executed, a process function corresponding to opcode (i.e. operation code) of the instruction, which has been stored in a register of CPU, is searched for. If the instruction execution program cannot find the process function, a malicious attack is judged as having taken place, and thus the execution of the instruction on the IC card is stopped.

Still further, Japanese Unexamined Patent Publication No. JP-A-2009-251794 discloses a data processor which performs a desired processing while decoding, in real time, an encrypted instruction code previously stored in a memory.

### SUMMARY

According to the techniques as described in the patent documents JP-A-2006-18528, JP-A-5-324408 and JP-A-2009-187438, a malfunction is prevented by detecting an undefined instruction, and interrupting a program or stopping the execution thereof after the program has been rewritten to form the undefined instruction. The inventor examined these techniques, and thus found that if a program is rewritten by an instruction other than an undefined instruction, it cannot be detected by those techniques, and therefore the instruction resulting from the rewrite—erroneous in content—would be executed, and further an instruction subsequent thereto would be executed.

To raise the level of security, in case that not only an undefined instruction, but also an instruction not arising in a program is sent to CPU, it is necessary to detect the instruction, and then stop the execution of the program. A measure effective against an attack of a type which causes a malfunction can be taken by: adopting, as a coding method used at the time of storing an instruction in a memory device, one which depends on an immediately preceding instruction; and decoding an instruction sequence, which has been coded according to the coding method. According to the arrangement like this, in case that an instruction read from a memory device is false, the effect of the measure can be kept on not only the instruction in question, but also a subsequent instruction sequence.

In any of the patent documents JP-A-2006-18528, JP-A-5-324408, JP-A-2009-187438, and JP-A-2009-251794, the problem as described above is not taken into account.

Therefore, it is an object of the invention to provide a technique which can raise the level of security by means of controlling the action of CPU not only in the case of a program rewritten by an undefined instruction, but also in the case of the program rewritten by an instruction other than an undefined instruction.

The above and other objects of the invention, and novel features thereof should be clear from the description hereof and the accompanying drawings.

Of embodiments of the invention herein disclosed, a representative one will be described below in brief.

A data processor according to the embodiment includes: a memory device for storing a program compiled by a compiler; and a CPU operable to fetch and execute an instruction code included in the program stored in the memory device. Further, the data processor has a filter for making a judgment about an instruction code to limit the action of CPU in case that CPU fetches the instruction code which the compiler never outputs.

The effect achieved by the representative embodiment of the invention is as follows in brief.

It is possible to provide a technique which can raise the level of security by means of controlling the action of CPU not only in the case of a program rewritten by an undefined instruction, but also in the case of the program rewritten by an instruction other than an undefined instruction.

### BRIEF DESCRIPTION OF THE DRAWINGS

FIG. 1 is a diagram for explaining an IC card with a microcomputer arranged as an example of the data processor in connection with the invention;

FIG. 2 is a block diagram showing an example of the configuration of the microcomputer;

FIG. 3 is a diagram for explaining a bit pattern arising on a memory device of the microcomputer;

FIG. 4 is a block diagram showing an example of the configuration of the microcomputer;

FIG. 5 is a block diagram showing an example of the configuration of the microcomputer;

FIG. 6 is a block diagram showing an example of the configuration of the microcomputer;

FIG. 7 is a block diagram showing an example of the configuration of a decoder included by the microcomputer;

FIG. 8 is a block diagram showing an example of the configuration of a decoder included by the microcomputer;

FIG. 9 is a block diagram showing an example of the configuration of a decoder included by the microcomputer;

FIG. 10 is a block diagram showing an example of the configuration of a converter unit included by the decoder;

FIG. 11 is a diagram for explaining an example of the configuration of a transpose unit included by the converter unit;

FIG. 12 is a diagram for explaining a bijection conversion performed by a bijectionconverter unit included by the converter unit;

FIG. 13 is a block diagram showing an example of the configuration of an address-information-degenerating device included by the decoder;

FIG. 14 is a circuit diagram showing an example of the configuration of an important portion in the address-information-degenerating device;

FIG. 15 is a flow chart showing a program arrangement;

FIG. 16 is a diagram for explaining a basic block of a program;

FIG. 17 is a diagram for explaining a code block of a program;

FIG. 18 is a diagram for explaining a basic block of a program;

FIG. 19 is a diagram for explaining an example of the configuration of a filter included by the microcomputer; and

FIG. 20 is a diagram for explaining appearance information stored in an instruction-code-appearance-information-table-storing unit.

### DETAILED DESCRIPTION

### Summary of the Embodiments

The embodiments of the invention herein disclosed will be outlined first. Here, the reference numerals for reference to the drawings, which are accompanied with paired round brackets, only exemplify what the concepts of members or components referred to by the numerals contain.

[1] A data processor (107) according to an embodiment of the invention includes: a memory device (220) for storing a program compiled by a compiler; and a CPU (210) operable to fetch and execute an instruction code included in the program stored in the memory device. Further, the data processor has a filter (430) for making a judgment about an instruction code to limit the action of CPU in case that CPU fetches the instruction code which the compiler never outputs.

The instruction code which the compiler never outputs refers to, of instructions which CPU can interpret, an instruction which is never created by means other than a direct writing of an assembler instruction if describing anything as a source code.

According to the above arrangement, the filter makes a judgment about an instruction code to limit the action of CPU incase that CPU fetches the instruction code which the compiler never outputs. Thus, it becomes possible to limit the action of CPU in the case where a program is rewritten not only by an undefined instruction, but also by another instruction other than an undefined instruction. Therefore, the security level can be raised.

[2] In regard to the data processor as described in [1], the instruction code which the compiler never outputs includes an instruction code which never appears in a program stored in the memory device. Hence, the filter may be arranged so as to make a judgment about an instruction code to limit the action of CPU in case that CPU fetches the instruction code which is not included by a program stored in the memory device.

[3] In regard to the data processor as described in [2], the filter may have an instruction-code-appearance-information-table-storing unit (2002) storing instruction code appearance information, and the instruction code appearance information includes data showing whether or not instruction codes stored in the memory device appear. According to the arrangement like this, the occurrence of a rewrite into an instruction which never appear in a program stored in the memory device can be readily judged by making reference to the instruction-code-appearance-information-table-storing unit.

[4] In regard to the data processor as described in [3], the instruction code appearance information stored in the instruction-code-appearance-information-table-storing unit consists of data about presence and absence of an instruction matching with each of bit patterns formed by a number of bits taken out of bits of a decoded instruction code.

[5] In regard to the data processor as described in [4], the instruction-code-appearance-information-table-storing unit may have the function of asserting a signal (420) for limiting, in action, CPU in case that CPU fetches an instruction code included in a program stored in the memory device. According to the arrangement like this, a signal (420) for limiting, in action, CPU is asserted by referring to the instruction-code-appearance-information-table-storing unit on occurrence of rewrite into an instruction which never arises in a program stored in the memory device. Therefore, the action of CPU can be limited readily. Now, it is noted that the limitation on the action of CPU includes an action for causing CPU to transition to a predetermined interrupt step in response to assertion of the signal (420), and an action for resetting CPU per se in response to assertion of the signal (420).

[6] In regard to the data processor as described in [5], as an instruction code included in a program stored in the memory device, an instruction code coded according to a coding method depending on an instruction code last executed may be adopted.

[7] In regard to the data processor as described in [5], as an instruction code included in a program stored in the memory device, an instruction code coded according to a coding method depending on an instruction code last executed, and address information corresponding to the instruction code may be adopted.

[8] The data processor as described in [6] may have a decoder (620) placed between the CPU and memory device, and operable to decode a coded instruction code according to the coding method. In the data processor, the decoder may include: a memory unit (720) for storing an instruction code last decoded; a selector (740) for selecting, when an instruction code last decoded cannot be decided uniquely, a predetermined initial value instead of the instruction code; and an exclusive OR computing circuit (750) for determining an exclusive OR of the coded instruction code and an output of the selector.

On condition that n instruction code coded according to a coding method depending on an instruction code last executed is adopted as an instruction code included by a program stored in the memory device, the decoder (620) can decode the coded instruction code. In the case of the arrangement like this, once a false decode is performed, it affects decode of a next instruction code, and therefore all the decodes of subsequent instruction codes end up as errors. On this account, an incorrectly decoded instruction code is discriminated by the filter (430) in due time, and then a stop signal (420) is asserted. As a wrong instruction fetch is continued, the probability of CPU (210) keeping running away decreases exponentially, whereas the probability of stop of CPU nears 100%. Therefore, the arrangement as described above is very useful for raising the level of security.

[9] The data processor as described in [7] may have a decoder (620) placed between the CPU and memory device, and operable to decode a coded instruction code according to the coding method. In the data processor, the decoder includes: an address-information-degenerating device (820) for degenerating the address information to a bit length of the coded instruction code; and a first exclusive OR computing device (810) for determining an exclusive OR of the address information subjected to degeneration by the address-information-degenerating device and coded instruction code. Also, the decoder includes: a memory unit (720) for storing an instruction code last decoded; a selector (740) for selecting, when an instruction code last decoded cannot be decided uniquely, a predetermined initial value instead of the instruction code; and a second exclusive OR computing device (750) for determining an exclusive OR of an output of the first exclusive OR computing device and an output of the selector. Also in the case of the arrangement like this, once a false decode is performed, it affects decode of a next instruction code, and therefore all the decodes of subsequent instruction codes end up as errors. As described above, as a wrong instruction fetch is continued, the probability of CPU (210) keeping running away decreases exponentially, whereas the probability of stop of CPU nears 100%. Therefore, the arrangement as described above is very useful for raising the level of security.

[10] An IC card (108) incorporating the data processor as described in [8] may be arranged.

[11] An IC card (108) incorporating the data processor as described in [9] may be arranged.

### 2. Further Detailed Description of the Embodiments

Now, the embodiments will be described further in detail.

The embodiments below are not limited by the number of members or components and other factors including a figure, a quantity and a range, which are cited in the description below, except when expressly specified otherwise or unquestionably limited to a certain numeric value in theory. The number of members or components and other factors described herein may be other values. As to the embodiments below, it is obvious that the constituents thereof, including elemental process steps or the like, are not necessarily essential except when expressly specified otherwise or unquestionably considered to be essential in theory. Likewise, with the embodiments below, the forms and positional relations of the constituents and other structures herein described include substantially forms and relations approximate or similar to them except when expressly specified otherwise or unquestionably considered not to be so in theory. The same thing can be said for the figure and range as described above.

The embodiments of the invention will be described below in detail with reference to the drawings. As to all the drawings for explaining the embodiments, like members shall be identified by the same reference numeral, character or sign, and the repetition of the description thereof is avoided.

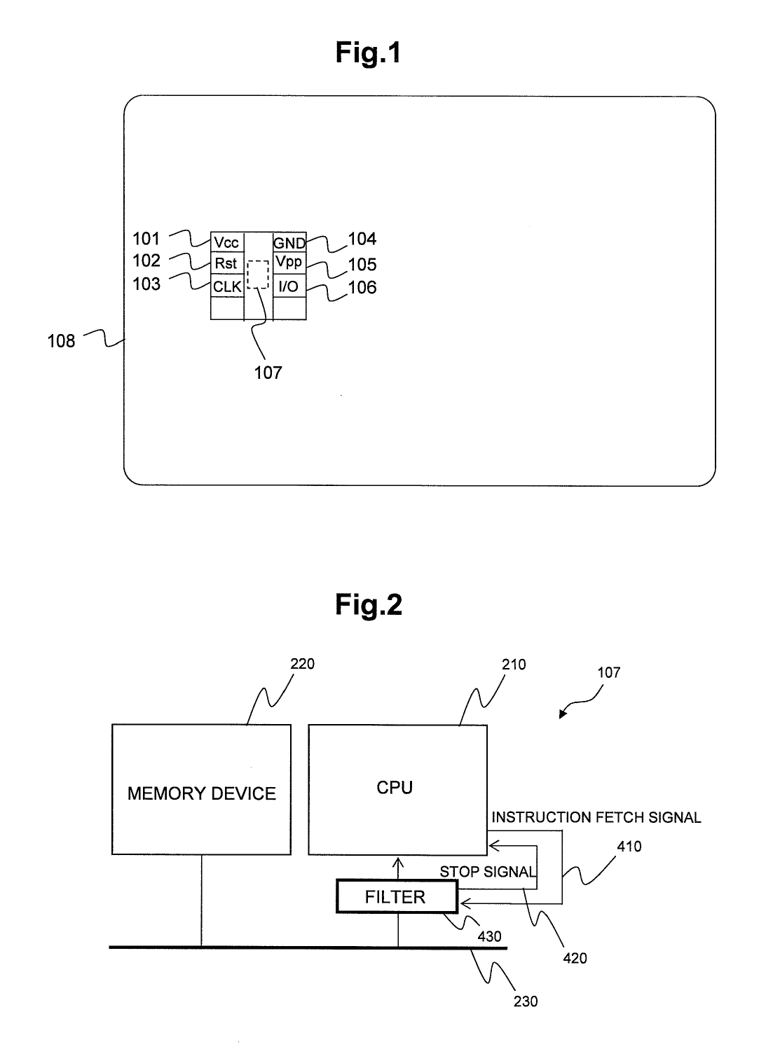

FIG. 1 shows an IC card with a microcomputer mounted therein; the microcomputer is an example of a data processor according to the invention. The IC card 108 shown in FIG. 1 has a microcomputer 107 incorporated therein, and a plurality of terminals 101-106 connected with the microcomputer 107. When the IC card 108 is inserted into a reader-writer device (not shown), the terminals 101-106 are brought into contact with terminals of the reader-writer device. Thus, it becomes possible to exchange a signal between the microcomputer 107 and the reader-writer device. The terminal 101 is a supply terminal for supply of a source voltage Vcc. The terminal 102 is an input terminal for input of a reset signal Rst. The terminal 103 is an input terminal for input of a clock signal CLK. The terminal 104 is a supply terminal of supply of a ground level, which is denoted by “GND”. The terminal 105 is a supply terminal for supply of a high voltage Vpp. The terminal 106 is one for data input and output, which is denoted by “I/O”.

FIG. 2 shows an example of the configuration of the microcomputer 107. Although no special restriction is intended, the microcomputer 107 includes a memory device 220, a CPU (Central Processing Unit) 210, and a filter 430, and is formed on a semiconductor substrate, such as a substrate made of monocrystalline silicon by the known semiconductor IC manufacturing technology. Although no special restriction is intended, the memory device 220 is composed of a nonvolatile memory, such as a flash memory. In the memory device 220, a program which is executed by CPU 210 and various kinds of data are stored. The program executed by CPU 210 refers to an execution-type object code resulting from the compilation of a source code by a compiler, which is termed “instruction code”. The CPU 210 fetches, through a bus 230, an instruction code forming a program stored in the memory device 220, and executes the instruction code. Between the bus 230 and CPU 210 is placed a filter 430. The filter 430 has the function of making a judgment about an instruction code to limit the action of CPU 210 in case that CPU 210 fetches the instruction code which the compiler never outputs. For instance, in case that the data sent to CPU 210 through the bus 230 is an instruction code, it is judged whether or not the instruction code is an instruction code included in a program in the memory device 220. The CPU 210 provides the filter 430 with an instruction fetch signal 410. The filter 430 discriminates between an instruction code and data based on the instruction fetch signal 410 conveyed. In case that a group of instructions constituting the program does not include the fetched code, the filter 430 asserts a stop signal 420 thereby to notify CPU 210 of occurrence of abnormal fetch. According to the assertion of the stop signal 420, CPU 210 goes into a step of interruption, or performs an action to reset itself, thereby stopping the abnormal action of the program.

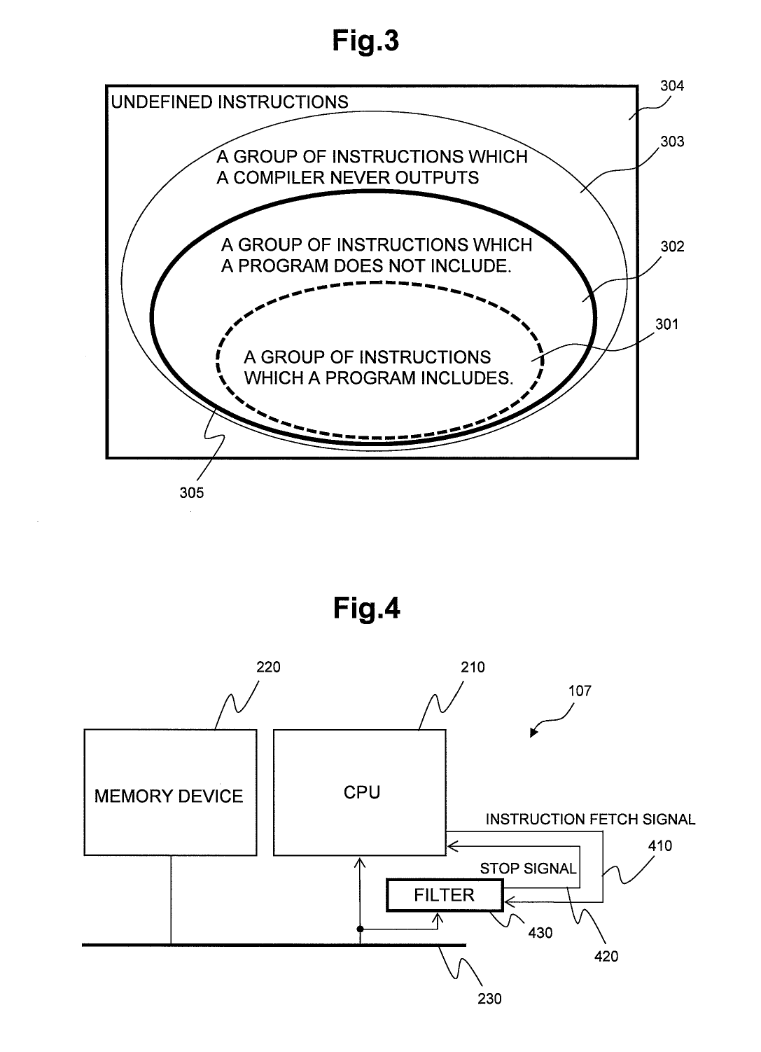

FIG. 3 shows an example of the bit pattern arising on the memory device 220. A group of data which CPU 210 cannot interpret are classified as an undefined instruction 304. There are a group of instructions 303 which can be interpreted and executed as an instruction but the compiler never outputs. The instruction which the compiler never outputs refers to, of instructions interpretable to CPU, an instruction which is never created by means other than a direct writing of an assembler instruction if describing anything as a source code. CPU with a high register orthogonality has no limitation in a register which can be specified by a computing instruction, and therefore there is also a computing instruction involving a combination of registers of little consequence as an instruction which CPU can interpret. Usually the compiler never outputs the instruction of adding up an upper portion of a register storing a stack address and a lower portion thereof, and then substituting the result of the addition for the upper portion, for example.

What belongs neither to the undefined instructions 304 nor to the group of instructions 303 which the compiler never outputs is a group of instructions 305 which the compiler can output. The group of instructions 305 are classified into a group of instructions 301 included by a program, and a group of instructions 302 included by no program. The group of instructions 302 included by no program refers to a group of instructions which are not output depending on the way to describe a source program input to the compiler. Inside the group of instructions 302, there is a group of instructions 301 which are included by a program. The memory device 220 has therein only the group of instructions 301 which are included by a program. Incase that an instruction code fetched by CPU 210 does not belong to “the group of instructions 301 which are included by a program”, it can be considered that some error occurred at the fetch. In this embodiment, in case that an instruction fetched and decoded does not belong to “the group of instructions 301 which are included by a program”, the filter 430 judges that a fatal error has occurred in fetch from a program, and asserts the stop signal 420 to stop the action of CPU 210.

The group of instructions 301 which are included by a program is created by a development tool for developing a program at the time of creating an object code to be stored in the memory device 220.

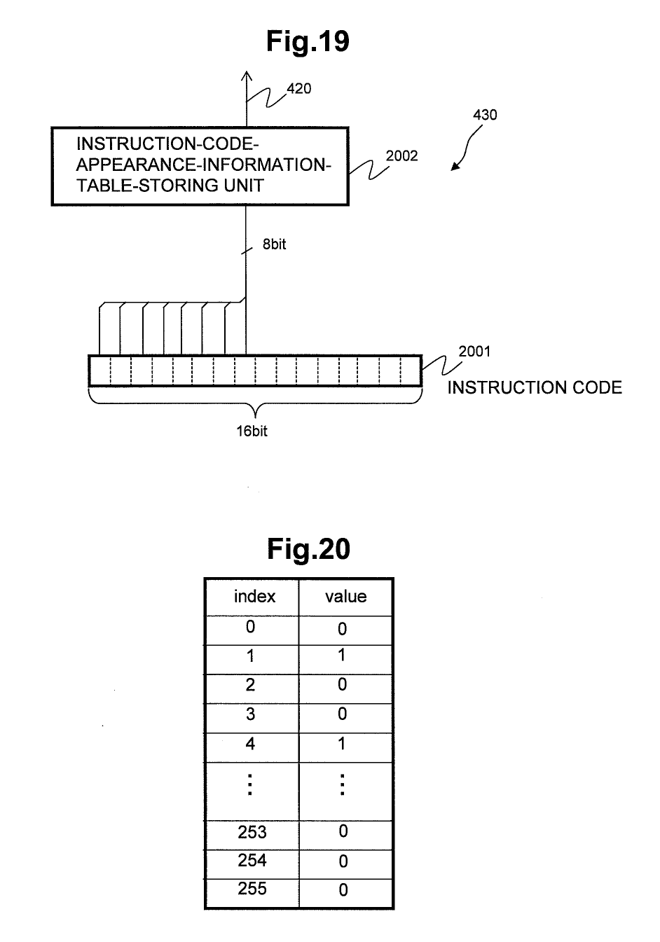

FIG. 19 shows an example of the configuration of the filter 430. Although no special restriction is intended, the filter 430 includes an instruction-code-appearance-information-table-storing unit 2002. Stored in the instruction-code-appearance-information-table-storing unit 2002 is information about appearance of the instruction code 2001. FIG. 20 shows examples of pieces of the appearance information stored in the instruction-code-appearance-information-table-storing unit 2002. The instruction code appearance information consists of pieces of information about the presence or absence of data of predetermined bit portions taken out of the instruction code 2001; the pieces of information are classified according to the numbers which the bit portions are labeled with. In regard to the instruction-code-appearance-information table, the number of each bit portion is used as an index value. If an instruction code having a bit portion number coincident with the index value of the table appears, a one-bit value, e.g. the logical value “1” for showing that the instruction appears is stored in VALUE column corresponding, in position in the table, to the index value. If an instruction having a bit portion number coincident with the index value of the table does not appear, a one-bit value, e.g. the logical value “0” for showing that the instruction does not appear is stored. Thus, the values of VALUE column is output as a stop signal 420. In the example of the configuration shown in FIG. 19, high-order eight bits of an instruction code are selected, and instruction codes are classified according to the numbers which the selected eight bits are labeled with, which makes possible to judge whether or not an instruction appears. However, the number of selected bits is not limited to eight. While the increase in the number of bits allows a more precise judgment on an instruction which never appears, the size of the instruction-code-appearance-information table increases according to a power of 2. Even if the same number of bits is selected, the detection ratio of “an instruction which never appears” varies depending on the positions where the selected bits are located. The positions of the selected bits are selected so as to maximize the detection ratio of “an instruction which never appears”. What meaning the selected bits of an instruction code each have depends on CPU. Therefore, the filter is designed so that a different combination of selected bits are selected for CPU which handles a different instruction set.

It is noted that it is possible to prepare two or more instruction-code-appearance-information tables, and to switch the instruction-code-appearance-information table depending on the programs in execution.

FIG. 4 shows another example of the configuration of the microcomputer 107.

The microcomputer 107 shown in FIG. 4 substantially differs from the microcomputer shown in FIG. 2 in that data on the bus 230 is sent to both the CPU 210 and filter 430. The filter 430 makes a judgment about whether data on the bus 230 is a fetched instruction code or data which CPU 210 has gained by memory access. The judgment is made based on the instruction fetch signal 410. If the instruction fetch signal 410 has been asserted, the data on the bus 230 is judged to be a fetched instruction code. In contrast, if the instruction fetch signal 410 has been negated, the data is judged to be data which CPU 210 has gained by memory access. In case that the data on the bus is judged to be a fetched instruction code, the filter 430 makes a judgment about whether or not the instruction code on the bus 230 belongs to a group of instructions included by the program. If it is judged that a group of instructions constituting the program does not include the instruction code on the bus 230, the filter 430 asserts a stop signal 420 thereby to notify CPU 210 of the occurrence of an abnormal fetch. According to the assertion of the stop signal 420, CPU 210 goes into a step of interruption, or performs an action to reset itself, thereby stopping the abnormal action of the program.

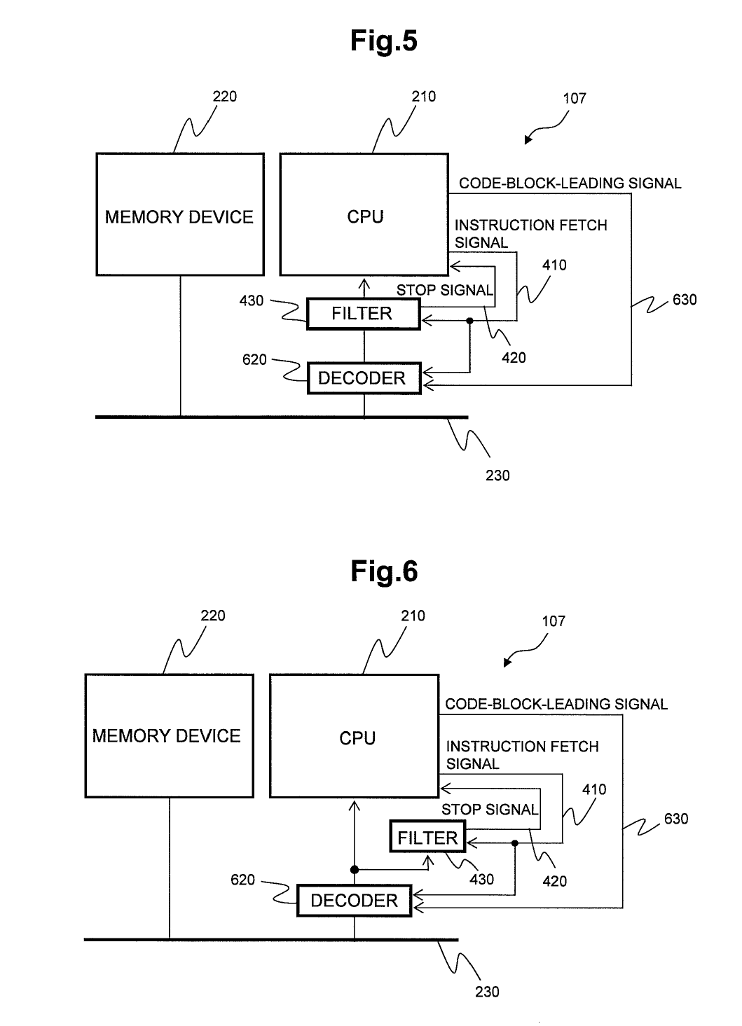

FIG. 5 shows another example of the configuration of the microcomputer 107. The microcomputer 107 shown in FIG. 5 substantially differs from the microcomputer shown in FIG. 2 in that a program stored in the memory device 220 is coded. The coding depends on an instruction code last executed. Further, the microcomputer 107 has a decoder 620 for decoding a coded instruction code between the bus 230 and the filter 430. The coded instruction code is decoded by the decoder 620, and conveyed through the filter 430 to CPU 210. The filter 430 judges whether or not an instruction code decoded by the decoder 620 belongs to a group of instructions included by the program. If the instruction code sent from the decoder 620 does not belong to the group of instructions included by the program, the filter 430 asserts a stop signal 420 thereby to notify CPU 210 of the occurrence of an abnormal fetch. The filter 430 and decoder 620 serve to discriminate between an instruction code and data based on the instruction fetch signal 410 from CPU 210. In the case of the coding depending on an instruction code last executed, if an instruction last executed cannot be decided uniquely, a value termed “initial vector” is used instead of the instruction last executed. The CPU 210 notifies, by means of the code-block-leading signal 630, that the instruction last executed is not decided. On detection of a jump instruction, a conditional branch, or an instruction for return from a subroutine, CPU 210 judges whether or not the instruction is located in the front portion of the code block.

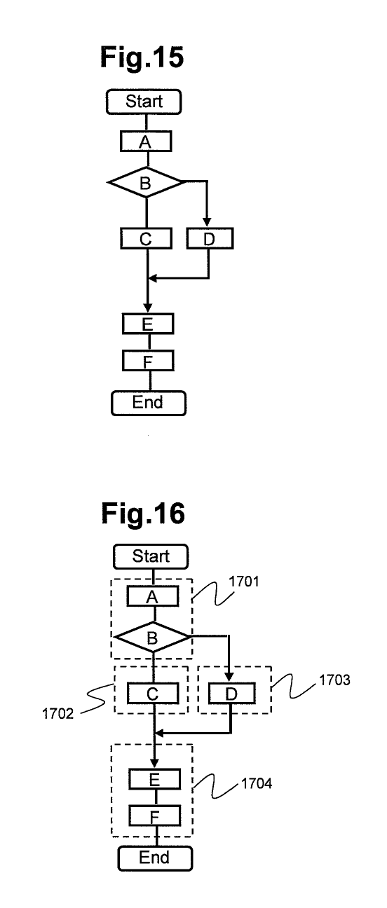

Here, the code block will be described. A code block is defined as a set of instruction sequences such that an instruction last executed is uniquely decided. A code block is similar to a basic block, but different from a basic block in the way to handle a non-branch subsequent to a branch instruction. A basic block refers to a sequence of instructions including no branch. For instance, a program including a plurality of instructions (or steps) A to F as shown in FIG. 15 is divided into four basic blocks 1701, 1702, 1703 and 1704 as shown in FIG. 16. Just after the branch instruction B, there is a basic block boundary between the instruction C of non-branch side and the branch instruction B.

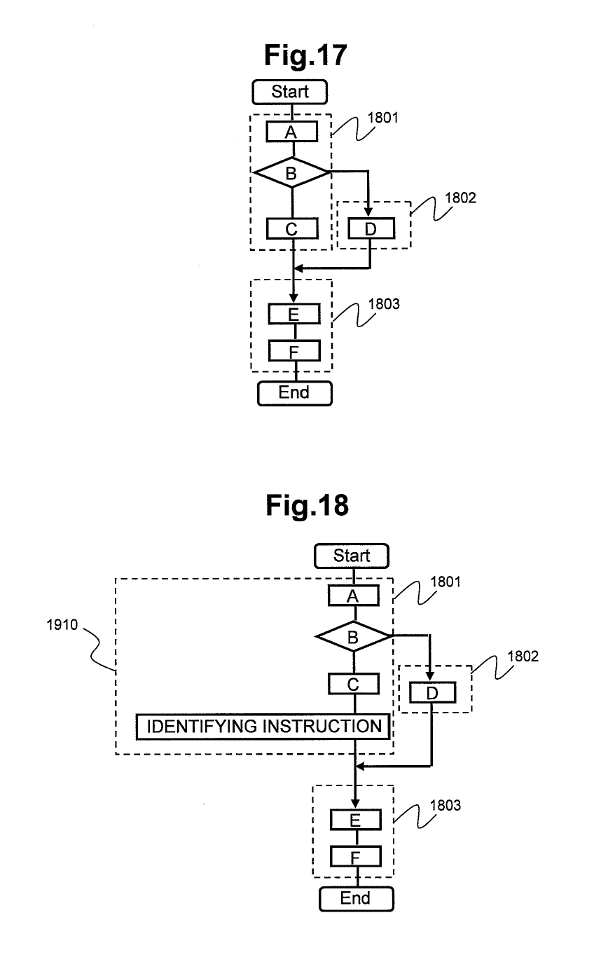

However, with a code block, even if the program execution proceeds into the non-branch side after execution of a branch instruction, there is no code block boundary. Therefore, the program is divided into three code blocks 1801, 1802 and 1803, as shown in FIG. 17.

The CPU 210 can identify the boundary between code blocks by use of a jump instruction, a branch instruction, an instruction for subroutine call and an instruction for return from a subroutine. Although there is a code block boundary between the instructions C and E as shown in FIG. 17, CPU 210 cannot identify the instruction C as it is, because the instruction C is usually neither a branch instruction nor a jump instruction. Hence, an identifying instruction 1910 is inserted between the instructions C and E so as to enable CPU 210 to identify a code block boundary as shown in FIG. 18. As the identifying instruction, a branch instruction for branching to an address immediately after the instruction C or a dedicated instruction for pointing a code block boundary may be prepared. For instance, an NOP (No Operation) instruction which means that nothing is performed can be used as the instruction pointing a code block boundary.

FIG. 6 shows another example of the configuration of the microcomputer 107. The microcomputer 107 shown in FIG. 6 substantially differs from the microcomputer shown in FIG. 4 in that a program stored in the memory device 220 is coded. The coding depends on an instruction code last executed. Further, the microcomputer 107 has a decoder 620 for decoding a coded instruction code between the bus 230 and the filter 430. An instruction code decoded by the decoder 620 is passed to the CPU 210, and the filter 430. The filter 430 judges whether or not an instruction code decoded by the decoder 620 belongs to a group of instructions included by the program. If the instruction code sent from the decoder 620 does not belong to the group of instructions included by the program, the filter 430 asserts a stop signal 420 thereby to notify CPU 210 of the occurrence of an abnormal fetch. The filter 430 and decoder 620 serve to discriminate between an instruction code and data based on the instruction fetch signal 410 from CPU 210. In the case of the coding depending on an instruction code last executed, if an instruction last executed cannot be decided uniquely, a special value termed “initial vector” is used instead of the instruction last executed. For this purpose, the CPU 210 notifies, by means of the code-block-leading signal 630, that the instruction last executed is not decided. Specifically, at the time of executing a jump instruction, a conditional branch, an instruction for return from a subroutine or the like, the CPU 210 notifies, by means of the code-block-leading signal 630, the respective modules that the instruction last executed cannot be decided uniquely.

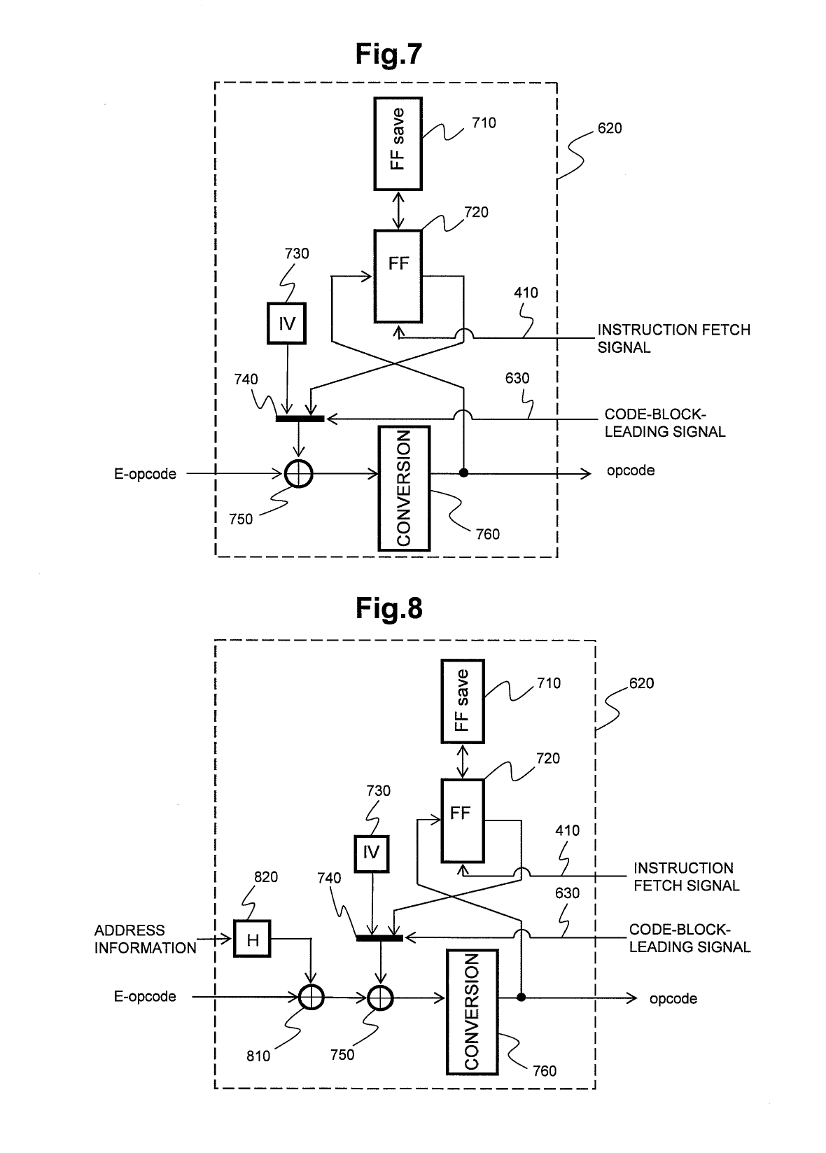

FIG. 7 shows an example of the configuration of the decoder 620. The decoder 620 shown in FIG. 7 includes: a memory device (FF save) 710; a memory unit (FF) 720; a selector 740; an exclusive OR computing device 750; and a converter unit 760. As the memory unit 720, a flip-flop circuit may be adopted. According to a method of coding depending on an immediately preceding instruction code, the decoder 620 decodes and outputs a coded instruction code sequence E-opcode. As to an instruction located in the front portion of a code block, an instruction code last executed cannot be decided uniquely, and therefore an initial value held by an initial-value register (IV) 730 is selected by the selector 740 instead. The selector 740 is controlled by the code-block-leading signal 630. The exclusive OR computing device 750 calculates an exclusive OR (XOR) of a coded instruction code, and a value of the memory unit 720 having an immediately preceding instruction code stored therein, or a signal selected by the selector 740, which is one of outputs from the initial-value register 730. Then, the resultant exclusive OR (XOR) undergoes a conversion by the converter unit 760. The converter unit 760 performs a conversion so that the ratio of an input value to an output value is 1:1, however the input and output are identical with each other in bit width. The output value of the converter unit 760 is output as a decoded instruction code, and stored in the memory unit 720 keeping an immediately preceding instruction code according to the value of the instruction fetch signal 410 in the case of an instruction fetch, otherwise the content of the memory unit 720 is not updated. The memory device 710 for evacuating an immediately preceding instruction code at the time of interruption is arranged so that the content of the memory unit 720 is evacuated on the occurrence of an interruption, whereas a value of the memory device 710, which is an immediately preceding instruction code at the time of interruption, and has been evacuated thereto, is used to restore the value of the memory unit 720 to the value before the interruption at the time of returning from the interruption.

With the decoder 620 shown in FIG. 7, once a false decode is performed, it affects decode of a next instruction code, and therefore all the decodes of subsequent instruction codes end up as errors. Now, if an address is represented by ADR, a coded instruction stored at the address ADR is represented by CCODE[ADR], a decoded instruction code is represented by PCODE[ADR], and a value resulting from a conversion of X by the converter unit 760 is represented by F(X), the coded instruction CCODE[ADR], and FF are as follows:

PCODE[ADR]:=F(PCCODE[ADR] XOR FF) Expression 1,

FF:=PCODE[ADR] Expression 2

where the symbol “:=” means an operation of substitution.

With the memory unit FF, IV is stored in the front portion of the code block, whereas PCODE[ADR-1] is stored in other portions, and therefore Expression 1 becomes as follows.

PCODE[ADR]:=F(CCODE[ADR] XOR PCODE[ADR−1]) Expression 3

Here, it is assumed that an error is caused at the time of fetching the coded instruction CCODE[ADR] at the address ADR, and CCODE′[ADR] is input instead of CCODE[ADR]. If CCODE′[ADR]≠CCODE[ADR], the value of a portion between parentheses of F on the right side of Expression 1 necessarily becomes as follows:

F(CCODE[ADR] XOR FF)≠F(CCODE′[ADR] XOR FF) Expression 4

Consequently, a false calculation result PCODE′ [ADR] for the address ADR is, as a matter of course, as follows:

PCODE′[ADR]≠PCODE′[ADR] Expression 5

While PCODE′[ADR] is substituted for FF, the value of PCODE′[ADR] is also false, and therefore FF′ is used instead of FF. Subsequently, at the time of decoding an instruction code at the address ADR+1, because the value of FF′ is not correct even under the situation where CCODE [ADR+1] is fetched correctly, the instruction code becomes likewise as given by Expression 6, and the result of decode for the address ADR+1 becomes a false value as presented by Expression 7.

F(CCODE[ADR+1] XOR FF)≠F(CCODE[ADR+1] XOR FF′) Expression 6,

PCODE′[ADR+1] Expression 7.

The value is substituted for FF, again. Therefore, the value of FF is kept a value different from a true value. Therefore, once a fetch error occurs, subsequent fetches all end up as errors.

An incorrectly decoded instruction code is discriminated by the filter 430 in due time, and then the stop signal 420 is asserted, whereby the action of CPU 210 is stopped. As a wrong instruction fetch is continued, the probability of CPU 210 keeping running away without stopping decreases exponentially, and the probability of stop of CPU 210 nears 100%. For instance, if the percentage of bit patterns, on detection of which the filter works to stop the action of CPU, is 20%, the probability of the filter stopping the action of CPU in a period of time taken for fetching ten instructions can be calculated in the way as shown by Expression 8.

1.0−(1.0−0.20)¹⁰≈0.893 Expression 8

FIG. 8 shows another example of the configuration of the decoder 620. In the example shown in FIG. 8, the decoder 620 is arranged so as to decode an instruction code subjected to a coding depending on an instruction code last executed, and the information of an address where the instruction code is stored. The address information is degenerated to a bit length the same as that of the coded instruction code E-opcode by the address-information-degenerating device (H) 820. Then, the exclusive OR computing device 810 computes the exclusive OR (XOR) of the degenerated address information and coded instruction code. The result of computation of the exclusive OR of the degenerated address information and the coded instruction code is conveyed to the exclusive OR computing device 750. Then, the exclusive OR computing device 750 computes the exclusive OR of the result of computation of the exclusive OR from the exclusive OR computing device 810, and a value selected by the selector 740. The selector 740 is controlled by the code-block-leading signal 630, and selects and outputs either an output value from the memory unit (FF) 720 with an immediately preceding instruction code stored therein, or an output value from the initial-value register 730. Incase that an instruction last decoded cannot be decided uniquely, the selector 740 selects an output value of the initial-value register 730. The result of computation by the exclusive OR computing device 750 undergoes a conversion by the converter unit 760. The converter unit 760 performs a conversion so that the ratio of an input value to an output value is 1:1, however the input and output are identical with each other in bit width. The output value opcode of the converter unit 760 is output as a decoded instruction code to CPU 210. In parallel with this, an output value of the memory unit 720 is stored in the memory unit 710 according to a value of the instruction fetch signal 410. In other words, in the case of an instruction fetch, the output of the converter unit 760 is stored in the memory unit 720, otherwise the content of the memory unit 720 is not updated. Also, the memory device (FF save) 710 is arranged so that the content of the memory unit 720 holding an immediately preceding instruction code is evacuated on the occurrence of an interruption, whereas a value of the memory device 710 is used to restore the value of the memory unit 720 to the value before the interruption at the time of returning from the interruption.

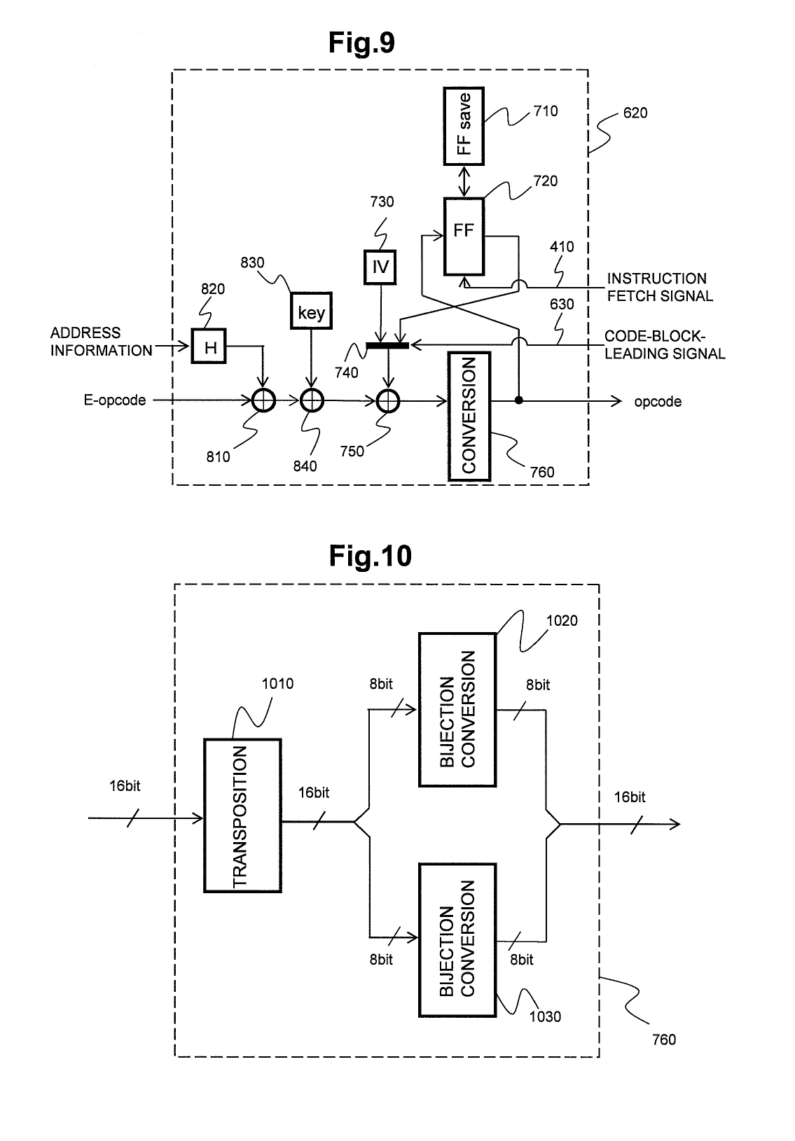

FIG. 9 shows another example of the configuration of the decoder 620. In the example shown in FIG. 9, the decoder 620 is arranged so as to decode an instruction code subjected to coding which depends on an instruction code last executed, key information stored in the memory device (key) 830, and information of an address where the instruction code is stored. The address information is degenerated to a bit length the same as that of the coded instruction code E-opcode by the address-information-degenerating device (H) 820. Then, the exclusive OR computing device 810 computes the exclusive OR of the degenerated address information and coded instruction code. The result of computation of the exclusive OR of the degenerated address information and the coded instruction code is conveyed to the exclusive OR computing device 840. Then, the exclusive OR computing device 840 computes the exclusive OR of the result of computation of the exclusive OR from the exclusive OR computing device 810, and key information stored in the key information memory device 830. The result of the computation is conveyed to the exclusive OR computing device 750. The exclusive OR computing device 750 computes the exclusive OR of the result of computation of the exclusive OR from the exclusive OR computing device 840, and a value selected by the selector 740. The selector 740 is controlled by the code-block-leading signal 630, and selects and outputs either an output value from the memory unit (FF) 720 with an immediately preceding instruction code stored therein, or an output value from the initial-value register (IV) 730. The result of computation by the exclusive OR computing device 750 undergoes a conversion by the converter unit 760. The converter unit 760 performs a conversion so that the ratio of an input value to an output value is 1:1, however the input and output are identical with each other in bit width. The output value of the converter unit 760 is output as a decoded instruction code. In parallel with this, the output value of the converter unit 760 is stored in the memory unit 720 for storing an immediately preceding instruction code according to a value of the instruction fetch signal 410 in the case of an instruction fetch, otherwise the content of the memory unit 720 is not updated. Also, the memory device (FF save) 710 is arranged so that the content of the memory unit 720 holding an immediately preceding instruction code is evacuated on the occurrence of an interruption, whereas a value of the memory device 710 is used to restore the value of the memory unit 720 to the value before the interruption at the time of returning from the interruption.

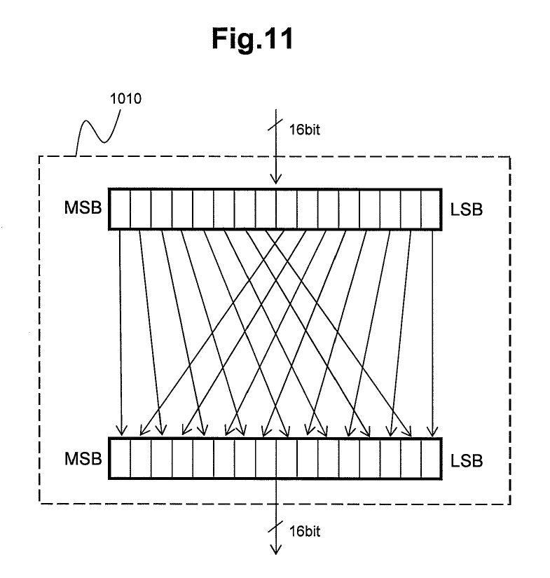

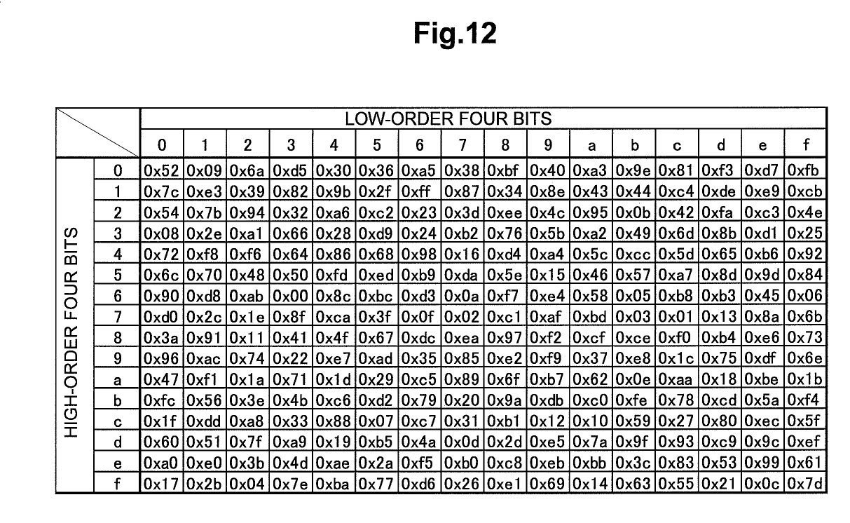

FIG. 10 shows an example of the configuration of the converter unit 760 included by the decoder 620. The converter unit 760 performs a bijection conversion while keeping its input and output to have the same bit length. In addition, it is desirable to arrange the converter unit 760 so that a difference of part of input bits propagates and spreads to output bits in addition to and other than the output bit corresponding to the input bit with the difference. In the example shown in FIG. 10, the transpose unit 1010 counterchanges the bits of a 16-bit value in position. For example, the transpose unit 1010 transposes bits of an input values so that high-order bits and low-order bits of the input value are disposed alternately as shown in FIG. 11. Now, it is noted that MSB and LSB in the drawing refer to the most significant bit and the least significant bit respectively. The way to transpose the bits is not limited to that as shown by FIG. 11, and another way may be adopted. After transposition of the bits by the transpose unit 1010, the resultant data is divided into a group of high-order bits and a group of low-order bits. The high- and low-order bit groups are subjected to conversion by the bijectionconverter units 1020 and 1030 respectively, and again organized into a 16-bit value. The converter unit 760 outputs the 16-bit value thus prepared. FIG. 12 shows examples of the bijection conversion by the bijectionconverter units 1020 and 1030. The table of FIG. 12 is one designed for InvSubByte conversion of bijection type used for AES cipher.

The bijection conversion cited here may be another conversion different from the conversion exemplified by the table of FIG. 12 as long as it is of bijection type.

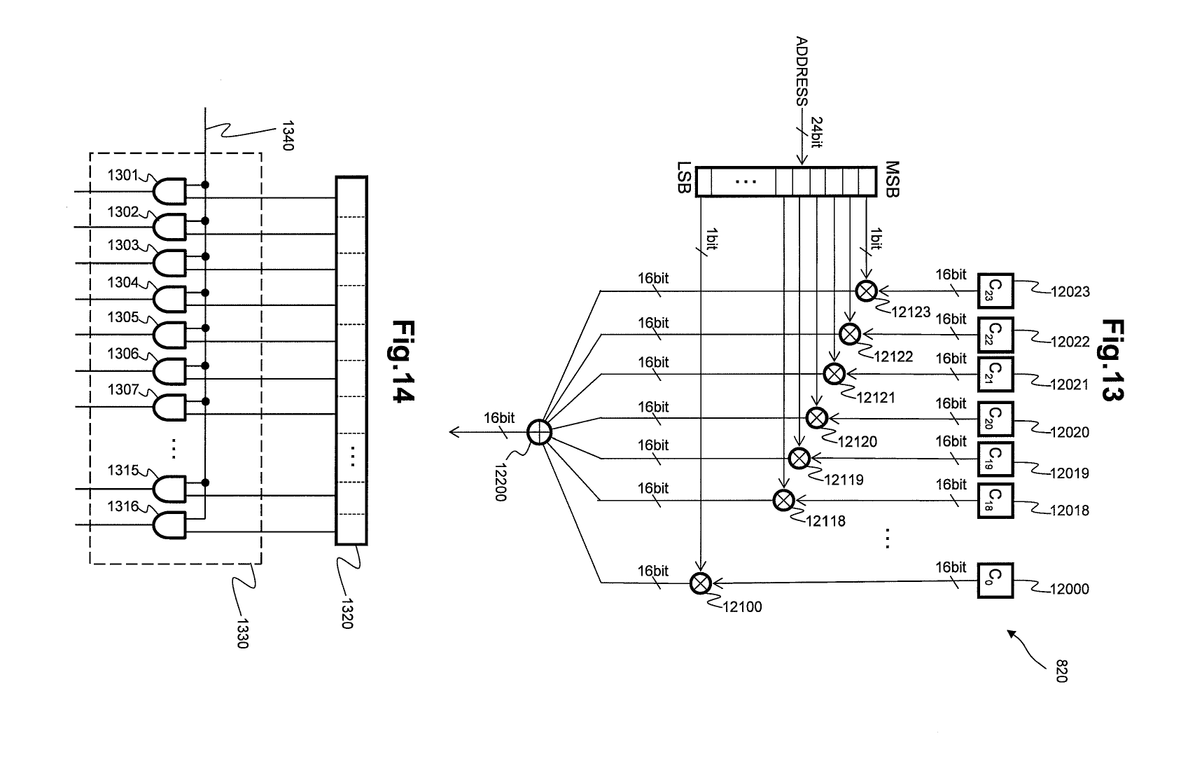

FIG. 13 shows an example of the configuration of the address-information-degenerating device 820 included by the decoder 620. The address-information-degenerating device 820 performs a conversion so as to adapt bit values of address information to the bit length of the unit of fetch at the time of instruction fetch. In the first step of the conversion, address information is divided in bits. As degenerating constants 12000(C0)-12023(C23) defined in bits have been prepared, in the next step, 1×16 squire-bit multiplier circuits 12100, 12118, 12119, 12120, 12121, 12122 and 12123 are used to obtain degenerating constants corresponding to bits having the logical value “1”, and then the exclusive OR circuit 12200 calculates the exclusive OR of all the degenerating constants. The degenerating constants have the same bit length as the bit length of the unit of fetch. The degenerating constants are set so that all of bit patterns in which post-degeneration values can be represented by the post-degeneration value bit lengths are created. At least focusing on the value of a certain bit of each degenerating constant, it is preferred for selection of the degenerating constants to prevent only one of the arising frequencies of “1” and “0” in the degenerating constants from being 100%.

FIG. 14 shows an example of the configuration of the 1×16 squire-bit multiplier circuits 12100, 12118, 12119, 12120, 12121, 12122 and 12123 in the address-information-degenerating device 820. The 1×16 squire-bit multiplier circuits include AND gates 1301-1316 arranged corresponding to bit numbers of the degenerating constant 1320. The 1×16 squire-bit multiplier circuits like this are used to calculate AND logic of the bits of the degenerating constant 1320 and one bit of address 1340, whereby a 1×16 squire-bit multiplication is performed. Incidentally, AND gates for bits of a degenerating constant having a value of “0” may be omitted.

While the embodiments of the invention made by the inventor have been described above concretely, the invention is not limited to them. It is obvious that various changes and modifications may be made without departing from the subject matter thereof.

What is claimed is:

1. A data processor comprising:
a memory device that stores a program compiled by a compiler;
a CPU operable to fetch and execute an instruction code included in the program stored in the memory device; and
a filter that discriminates an instruction code other than the compiler is expected to output and limits the CPU in action thereof in case that the CPU fetches the instruction code.

2. The data processor according to claim 1,
wherein the filter discriminates an instruction code other than included in a program stored in the memory device and limits the CPU in action thereof in case that the CPU fetches the instruction code.

3. The data processor according to claim 2,
wherein the filter includes an instruction-code-appearance-information-table-storing unit storing instruction code appearance information, and
wherein the instruction code appearance information includes data showing whether or not instruction codes stored in the memory device appear.

4. The data processor according to claim 3,
wherein the instruction code appearance information stored in the instruction-code-appearance-information-table-storing unit consists of data about presence and absence of an instruction matching with each of bit patterns formed by a number of bits taken out of bits of a decoded instruction code.

5. The data processor according to claim 4,
wherein the instruction-code-appearance-information-table-storing unit asserts a signal that limits the CPU in action thereof in case that the CPU fetches an instruction code included in a program stored in the memory device.

6. The data processor according to claim 5,
wherein an instruction code included in a program stored in the memory device is coded according to a coding method depending on an instruction code last executed.

7. The data processor according to claim 5,
wherein an instruction code included in a program stored in the memory device is coded according to a coding method depending on an instruction code last executed, and address information corresponding to the instruction code.

8. The data processor according to claim 6, further comprising:
a decoder placed between the CPU and the memory device, and operable to decode a coded instruction code according to the coding method,
wherein the decoder includes:
a memory unit that stores an instruction code last decoded;
a selector that selects, when an instruction code last decoded cannot be decided uniquely, a predetermined initial value instead of the instruction code; and
an exclusive OR computing circuit that determines an exclusive OR of the coded instruction code and an output of the selector.

9. The data processor according to claim 7, further comprising:
a decoder placed between the CPU and the memory device, and operable to decode a coded instruction code according to the coding method,
wherein the decoder includes:
an address-information-degenerating device that degenerates the address information to a bit length of the coded instruction code;
a first exclusive OR computing device that determines an exclusive OR of the address information subjected to degeneration by the address-information-degenerating device and the coded instruction code;
a memory unit that stores an instruction code last decoded;
a selector that selects, when an instruction code last decoded cannot be decided uniquely, a predetermined initial value instead of the instruction code; and
a second exclusive OR computing device that determines an exclusive OR of an output of the first exclusive OR computing device and an output of the selector.

10. An IC card comprising: the data processor according to claim 8.

11. An IC card comprising: the data processor according to claim 9.
